(19) United States
(12) Patent Application Publication
(10) Pub. No.: US 2025/0246675 A1
(43) Pub. Date: Jul. 31, 2025

(54) ALL-SOLID-STATE BATTERY

(71) Applicant: SAMSUNG ELECTRO-MECHANICS CO., LTD., Suwon-si, Gyeonggi-do (KR)

(72) Inventors: Jieun Wang, Suwon-si, Gyeonggi-do (KR); Jihyung Jung, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/688,710

(22) PCT Filed: Feb. 8, 2024
(86) PCT No.: PCT/KR2024/001875

§ 371 Date: Mar. 1, 2024

(30) Foreign Application Priority Data
Sep. 27, 2023 (KR) 10-2023-0130785

(51) Int. Cl. H01M 10/0562; H01M 10/052; H01M 10/0585

(52) U.S. Cl. CPC H01M 10/0562; H01M 10/052; H01M 10/0585; H01M 2300/0068

(57) ABSTRACT

An all-solid-state battery according to an embodiment includes: a solid electrolyte layer; a positive electrode layer and a negative electrode layer disposed with the solid electrolyte layer interposed therebetween; and margin layers disposed at edges of the positive electrode layer and the negative electrode layer, respectively, in a lateral direction, wherein the solid electrolyte layer includes a first solid electrolyte that is glass or glass ceramic that does not contain an element S (sulfur), and the margin layers include a second solid electrolyte that is glass or glass ceramic that contains the element S (sulfur).

### TECHNICAL FIELD

The present disclosure relates to an all-solid-state battery.

### BACKGROUND ART

Recently, the miniaturization and prolonged use of portable electronic devices requires high-capacity batteries, and the spread of wearable electronic devices requires securing the safety of the batteries. Therefrom, the development of all-solid-state batteries that use solid electrolytes instead of liquid electrolytes has been actively conducted.

All-solid-state batteries do not use flammable organic solvents, so additional circuits for safety may be simplified. Therefore, it is expected to be a technology capable of manufacturing high-capacity safe batteries per unit volume.

In addition, oxide all-solid-state batteries using oxide electrolytes have lower ionic conductivity of the electrolyte (10⁻⁴ S/cm to 10⁻⁶ S/cm) than sulfide (10⁻² S/cm), and require a high-temperature firing process, but they are more stable than sulfide all-solid-state batteries that use sulfide electrolytes that react with oxygen and moisture in the air.

The stacked oxide all-solid-state battery is an ultra-small battery that may be mounted on a board like a passive device and is stable even when exposed to high temperatures during a reflow process for this purpose.

Research to apply these stacked oxide all-solid-state batteries to a variety of applications has been conducted. In particular, the demand for all-solid-state batteries that may achieve co-sintering of each layer of the cell laminate at low temperatures while ensuring insulation properties has increased.

### DISCLOSURE OF INVENTION

### Solution to Problem

The present disclosure attempts to provide an all-solid-state battery having excellent both insulating properties and co-sintering properties.

However, the problems that the embodiments are intended to address are not limited to the problems described above and may be expanded in various ways within the scope of the technical ideas included in the embodiments.

### Advantageous Effects of Invention

The all-solid-state battery according to the embodiment has an advantage of being excellent in both insulating properties and co-sintering properties.

However, the various and beneficial advantages and effects of the present invention arc not limited to the foregoing, and will be more easily understood in the process of describing specific embodiments of the present invention.

### BRIEF DESCRIPTION OF DRAWINGS

FIG. 1 is a perspective view schematically showing an all-solid-state battery according to an embodiment.

FIGS. 2, 3, 4, 5, 6, 7, 8, and 9 are cross-sectional views of an all-solid-state battery according to an embodiment.

### BEST MODE FOR CARRYING OUT THE INVENTION

An all-solid-state battery according to an embodiment includes: a cell laminate including a solid electrolyte layer; a positive electrode layer and a negative electrode layer disposed with the solid electrolyte layer interposed therebetween; and margin layers disposed at edges of the positive electrode layer and the negative electrode layer, respectively, in a lateral direction, wherein the solid electrolyte layer includes a first solid electrolyte that is glass or glass ceramic that does not contain an element S (sulfur), and the margin layers include a second solid electrolyte that is glass or glass ceramic that contains the element S (sulfur).

An all-solid-state battery according to another embodiment includes: a cell laminate including a solid electrolyte layer, a positive electrode layer and a negative electrode layer disposed with the solid electrolyte layer interposed therebetween; and margin layers disposed at edges of the positive electrode layer and the negative electrode layer, respectively, in a lateral direction, and an outer layer disposed on one or both surfaces of the cell laminate in a stacking direction, wherein the solid electrolyte layer includes a first solid electrolyte that is glass or glass ceramic that does not contain an element S (sulfur), and the margin layer or the outer layer includes a second solid electrolyte that is glass or glass ceramic that contains the element S (sulfur).

### MODE FOR THE INVENTION

Hereinafter, with reference to the accompanying drawings, the present invention will be described in detail so as to facilitate practice by those having ordinary knowledge in the art to which the present invention belongs. In order to clearly illustrate the invention in the drawings, parts not pertinent to the description have been omitted, and identical or similar components are designated by the same reference numerals throughout the specification. Furthermore, the accompanying drawings are intended only to facilitate an understanding of the embodiments disclosed herein, and it is to be understood that the technical ideas disclosed herein are not limited by the accompanying drawings and include all modifications, equivalents, or substitutions that are within the scope of the ideas and technology of the present invention. In addition, some components are exaggerated, omitted, or schematically depicted in the accompanying drawings, and the dimensions of each component are not necessarily indicative of actual dimensions.

Throughout the present specification, unless explicitly described to the contrary, “comprising” any components will be understood to imply the inclusion of other components rather than the exclusion of any other components.

Throughout the specification, the “stacking direction” refers to a direction in which the components are stacked sequentially, and may also be a “thickness direction” perpendicular to a wide side (main plane) of the components on the sheet, which corresponds to a T-axis direction in the drawings. In addition, the “lateral direction” refers to a direction that extends from the edge of the component on the sheet, parallel to a wide surface (main surface), which may be a “plane direction” and corresponds to an L-axis direction in the drawings. In addition, a W-axis direction in the drawing may be a “width direction”.

Hereinafter, various embodiments and modifications will be described in detail with reference to the drawings.

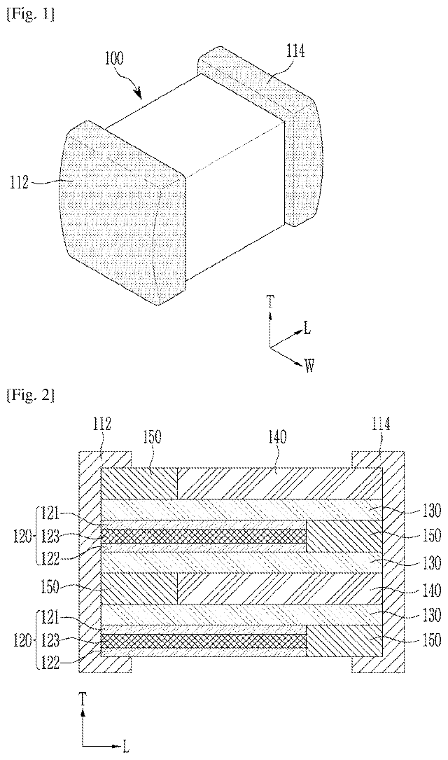

FIG. 1 is a perspective view schematically showing an all-solid-state battery according to an embodiment, and FIGS. 2 to 9 are cross-sectional views of an all-solid-state battery according to an embodiment.

As an example, the all-solid-state battery 100 may have a roughly hexahedral shape.

In the present embodiment, for convenience of explanation, in the all-solid-state battery 100, both surfaces opposing each other in a thickness direction (T-axis direction) will be defined as a first surface and a second surface, and both surfaces connected to the first surface and the second surface and opposing each other in a length direction (L-axis direction) will be defined as a third surface and a fourth surface. As an example, the first surface and second surface opposing each other of the all-solid-state battery 100 may be the third surface and the fourth surface.

The all-solid-state battery 100 according to an embodiment includes electrode layers 120 and 140 and a solid electrolyte layer 130 disposed adjacent to the electrode layers 120 and 140 in a stacking direction, and a margin layer 150 disposed at edges of the electrode layers 120 and 140, respectively, in a lateral direction.

### Solid Electrolyte Gave

The solid electrolyte layer 130 may be interposed and stacked between the positive electrode layer 120 and the negative electrode layer 140. Accordingly, the solid electrolyte layer 130 may be disposed adjacent to positive electrode active material layers 121 and 122 of the positive electrode layer 120 and negative electrode active material layers 141 and 142 of the negative electrode layer 140 in a stacking direction.

Thus, in the all-solid-state battery 100, a plurality of positive electrode layers 120 and negative electrode layer 140 may be alternately disposed and stacked with a plurality of solid electrolyte layers 130 interposed between them. The all-solid-state battery 100 may be a stacked all-solid-state battery 100 manufactured by alternately stacking a plurality of positive electrode layers 120 and negative electrode layers 140, interposing a plurality of solid electrolyte layers 130 between them to manufacture a cell laminate, and then firing them at a time.

As an example, the solid electrolyte layer 130 includes a first solid electrolyte that is glass or glass-ceramic that does not contain the element S (sulfur).

The glass means crystallographically amorphous, such as when halos are observed in X-ray diffraction or electron beam diffraction.

The glass-ceramic (or crystallized glass) refers to a crystallographic mixture of amorphous and crystalline materials, such as peaks and halos observed in X-ray diffraction or electron diffraction. Therefore, the glass-ceramic electrolyte is an electrolyte in which amorphous and crystalline materials are mixed because crystallization is partially performed through firing.

The first solid electrolyte may be any solid electrolyte as long as it is does not contain the element S (sulfur).

As an example, the first solid electrolyte may be an inorganic-based solid electrolyte, and as a specific example, may include an oxide-based solid electrolyte.

Oxide-based solid electrolytes may be Garnet-type, Nasicon-type, LISICON-type, perovskite-type, LiPON-type, or amorphous (glass) electrolytes.

Garnet-type solid electrolytes may refer to lithium lanthanum zirconium oxide (LLZO), represented by LiₐLa_{b}Zr_{c}O₁₂, such as Li₇La₃Zr₂O₁₂. Nasicon-type solid electrolytes may refer to lithium-aluminum-titanium-phosphate (LATP) of Li₁₊ₓAlₓTi₂₋ₓ(PO₄)₃ (0<x<1) where Ti is introduced into a compound of the type Li₁₊ₓAlₓM₂₋ₓ(PO₄)₃ (LAMP) (where 0<x<2, and M is Zr, Ti, or Ge), lithium-aluminum-germanium-phosphate (LAGP), represented by Li₁₊ₓAlₓGe₂₋ₓ(PO₄)₃ (0<x<1), such as Li_{1.3}Al_{0.3}Ti_{1.7}(PO₄), and/or lithium-zirconium-phosphate (LZP) of LiZr₂(PO₄)₃ with an excess of lithium introduced.

In addition, the LISICON-type solid electrolytes may be represented by xLi₃AO₄-(1−x)Li₄BO₄ (where A is P, As, or V, etc., and B is Si, Ge, or Ti, etc.), which may refer to solid solution oxides including Li₄Zn(GeO₄)₄, Li₁₀GeP₂O₁₂(LGPO), Li_{3.5}SiO_{0.5}P_{0.5}O₄, Li_{10.42}Si(Ge)_{1.5}P_{1.5}Cl_{0.08O11.92}, etc.

The perovskite-type solid electrolytes may refer to lithium-lanthanum titanate (LLTO), represented by Li₃ₓLa_{2/3-x}□_{1/3-2x}TiO (0<x<0.16, □: vacancy), such as Li_{1/8}La_{5/8} TiO₃, etc. The LiPON-type solid electrolytes may refer to a nitride, such as lithium-phosphorous oxynitride, such as Li_{2.8}PO_{3.3}N_{0.46}.

The amorphous electrolyte may include Li₂O—B₂O₃—SiO₂, Li₂O—B₂O—P₂O₅, or Li₃BO₃—Li₂CO₃.

As an example, the first solid electrolyte may be an oxide containing lithium (Li), and further containing boron (B), silicon (Si), aluminum (Al), phosphorus (P), germanium (Ge), chlorine (Cl), or combinations thereof.

As an example, the first solid electrolyte may be an oxide containing lithium (Li) and boron (B), and further containing silicon (Si), aluminum (Al), phosphorus (P), germanium (Ge), chlorine (Cl), or combinations thereof.

As an example, the first solid electrolyte may further contain an oxide comprising bismuth (Bi), barium (Ba), vanadium (V), antimony (Sb), tin (Sn), zinc (Zn), or combinations thereof.

The first solid electrolyte included in the solid electrolyte layer 130 may be an electrolyte having the same or similar composition to the second solid electrolyte included in the margin layer 150 described later, but differing only in the presence or absence of the element S (sulfur). In this case, a similar composition of electrolyte is used in the solid electrolyte layer and the margin layer, and a sintering temperature is similar, so that co-sintering may be achieved in the manufacture of stacked all solid-state batteries.

As an example, a sintering temperature of the first solid electrolyte may range from 470° C. to 550° C., for example, 480° C. to 550° C., 490° C. to 550° C., or 500° C. to 550° C. If the sintering temperature of the first solid electrolyte is less than 470° C., it is difficult to achieve densification of the solid electrolyte because it is not sufficiently sintered, and if it exceeds 550° C., deformation of the cell laminate may occur due to high temperature sintering.

An ionic conductivity of the first solid electrolyte included in the solid electrolyte layer 130 may be 1×10⁻⁷ S/cm or more. Ion conductivity may be a value measured at a temperature of 25° C. The ionic conductivity of the first solid electrolyte may be 1×10⁻⁷ S/cm or more, 1×10⁻⁶ S/cm or more, 2×10⁻⁶ S/cm or more, 3×10⁻⁶ S/cm or more, 4×10⁻⁶ S/cm or more, or 5×10⁻⁶ S/cm or more, with the upper limit not being particularly limiting. When a solid electrolyte satisfying the ionic conductivity of the range is used, the all-solid-state battery 100 may exhibit high output.

The ionic conductivity of the first solid electrolyte may be measured by an alternating current impedance method.

First, the solid electrolyte layer is exposed in the all-solid-state battery by ion milling or polishing, and a portion of the solid electrolyte layer is sampled as a rectangular plate-like piece. The sample is then prepared by forming an electrode made of gold (Au) at both ends of the obtained piece.

Then, the ionic conductivity may be calculated by measuring the alternating current impedance (frequency: measured from 10⁻⁶ Hz or more to 10⁻¹ Hz or less, voltage: a value between 50 mV and 500 mV) on the sample at room temperature (25° C.) using an impedance measurement device.

Alternatively, a sample may be prepared by first preparing a pellet made of the first solid electrolyte, sintering the pellet at 470° C. to 550° C., and forming an electrode made of gold (Au) at both ends of the pellet, thereby calculating the ionic conductivity in the same manner as described above.

### Marin Layer

A margin layer 150 may be further disposed along the edges of the positive electrode layer 120 and the negative electrode layer 140, respectively.

Referring to FIGS. 2 to 5, the margin layer 150 may be located on the solid electrolyte layer 130 and may be disposed at edges of the positive electrode active material layers 121 and 122 or the negative electrode active material layers 141 and 142 in a lateral direction.

Accordingly, the margin layer 150 may be located in the same layer of the positive electrode layer 120 and the negative electrode layer 140, respectively.

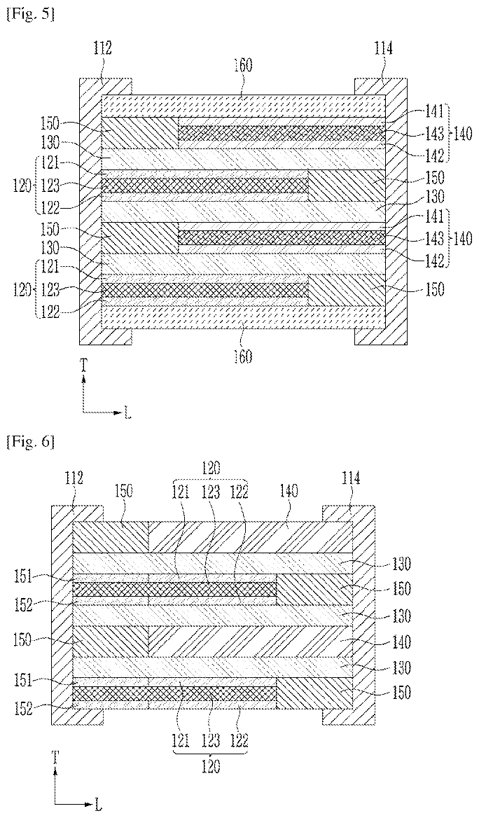

Referring to FIGS. 6 to 9, the margin layers 151 and 152 may be disposed adjacent to the edges of the positive electrode active material layers 121 and 122 in a lateral direction, and may be separated with a positive electrode current collector 123 interposed in a stacking direction in order to adjoin the positive electrode current collector 123 to an external electrode 112. Accordingly, the positive electrode active material layers 121 and 122 may not be connected to the external electrode 112 by the margin layers 151 and 152.

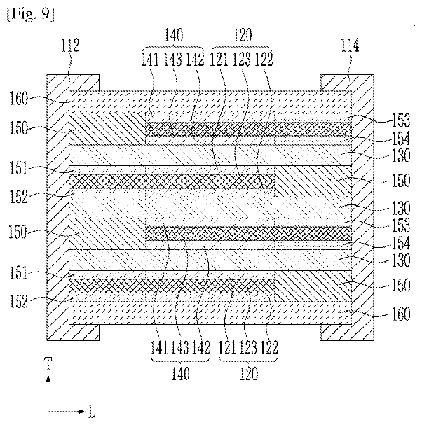

Referring to FIGS. 8 and 9, the margin layers 153 and 154 may be disposed adjacent at the edges of the negative electrode active material layers 141 and 142, respectively, in a lateral direction, and may be separated with a negative electrode current collector 143 interposed in a stacking direction in order to adjoin the negative electrode current collector 143 to an external electrode 114. Accordingly, the negative electrode active material layers 141 and 142 may not be connected to the external electrode 114 by the margin layers 153 and 154.

In one embodiment, the margin layer 150 includes a second solid electrolyte that is glass or glass ceramic that contains the element S (sulfur).

As an example, the second solid electrolyte may be an inorganic-based solid electrolyte, and as a specific example, may include an oxide-based solid electrolyte.

As an example, the second solid electrolyte may be an oxide containing lithium (Li) and sulfur (S), and further containing boron (B), silicon (Si), phosphorus (P), aluminum (Al), germanium (Ge), chlorine (Cl), or combinations thereof.

As an example, the second solid electrolyte may be an oxide containing lithium (Li), sulfur (S), boron (B), and silicon (Si), and further containing aluminum (Al), phosphorus (P), germanium (Ge), chlorine (Cl), or combinations thereof.

As an example, the second solid electrolyte may further contain an oxide comprising bismuth (Bi), barium (Ba), vanadium (V), antimony (Sb), tin (Sn), zinc (Zn), or combinations thereof.

The second solid electrolyte included in the margin layer 150 may be an electrolyte having the same or similar composition to the first solid electrolyte layer included in the solid electrolyte layer 130 described above, but differing only in the presence or absence of the element S (sulfur). In this case, a similar composition of electrolyte is used in the solid electrolyte layer and the margin layer, and a sintering temperature is similar, so that co-sintering may be achieved in the manufacture of stacked all-solid-state batteries.

As an example, the sintering temperature of the second solid electrolyte may range from 470° C. to 550° C., for example, 480° C. to 550° C., 490° C. to 550° C., or 500° C. to 550° C. If the sintering temperature of the second solid electrolyte is less than 470° C., it is difficult to achieve densification of the solid electrolyte because it is not sufficiently sintered, and if it exceeds 550° C., deformation of the cell laminate may occur due to high temperature sintering.

Since the first solid electrolyte and the second solid electrolyte may be sintered at a similar range of low temperatures as described above, co-sintering is possible in the manufacture of stacked all-solid-state batteries.

As an example, the second solid electrolyte may be included in an amount of 20% by weight or more, 25% by weight or more, or 30% by weight or more, and may be included in an amount of 100% by weight, 95% by weight or less, or 90% by weight or less, based on the total of the margin layer 150. If the second solid electrolyte is contained in an amount of less than 20% by weight, based on the total of the margin layer 150, it may be difficult to achieve insulation properties of the margin layer 150. Here, the % weight amount of the second solid electrolyte may be obtained in one of the margin layers 150, or may be an average value obtained in two or more of the margin layers 150. In one embodiment, the % weight amount of the second solid electrolyte may be obtained in each of the margin layers 150. For the % weight amount of the second solid electrolyte, other measurement methods and/or tools appreciated by one of ordinary skill in the art, even if not described in the present disclosure, may also be used.

The ionic conductivity of the second solid electrolyte included in the margin layer 150 may be 5.0×10⁻⁹ S/cm or less. Ion conductivity may be a value measured at a temperature of 25° C. The ionic conductivity may be 5.0×10⁻⁹ S/cm or less, 1.0×10⁻⁹ S/cm or less, 5.0×10⁻¹⁰ S/cm or less, or 1.0×10⁻¹⁰ S/cm or less, with the lower limit not being particularly limiting. A method of measuring the ionic conductivity of the second solid electrolyte is the same as the method of measuring the ionic conductivity of the first solid electrolyte described above, except that a portion of the margin layer is sampled as a rectangular plate-like piece.

The margin layer 150 may include an insulating material having an ionic conductivity of 1.0×10⁻¹⁰ S/cm or less, or 1.0×10⁻⁶ S/cm or less, and may include, for example, an insulating material such as a ceramic or resin.

The ceramic may include alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, or oxides and/or nitrides of these materials.

For example, the resin may include polyolefin such as polyethylene or polypropylene, polyester such as polyethylene terephthalate (PET), polyurethane, or polyimide.

The insulating material such as ceramic or resin may be included in an amount of 0% by weight, 1% by weight or more, or 5% by weight or more, and may be included in an amount of 30% by weight or less, 25% by weight or less, or 20% by weight or less, based on the total of the margin layer 150. If the insulating material is included in an amount exceeding 30% by weight, based on the total of the margin layer 150, it may be difficult to achieve co-sintering with the margin layer 150 and the solid electrolyte layer 130. Here, the % weight amount of the insulating material may be obtained in one of the margin layers 150, or may be an average value obtained in two or more of the margin layers 150. In one embodiment, the % weight amount of the insulating material may be obtained in each of the margin layers 150. For the % weight amount of the insulating material, other measurement methods and/or tools appreciated by one of ordinary skill in the art, even if not described in the present disclosure, may also be used.

### Outer Layer

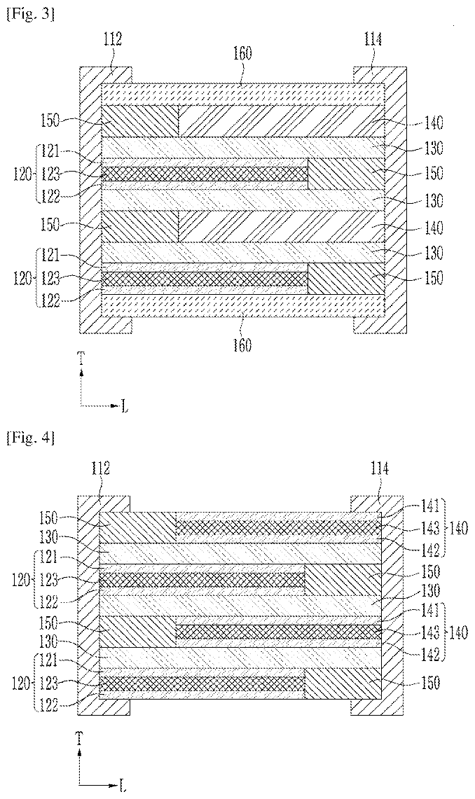

Referring to FIGS. 3, 5, and 7, an outer layer 160 may be further located on one or both sides in a stacking direction of the cell laminate of the all-solid-state battery 100. As an example, the outer layer 160 may be located on the outermost side in a stacking direction of the cell laminate of the all-solid-state battery 100. By being located on the outside of the cell laminate, the outer layer 160 may serve to cushion the impact of the all-solid-state battery, prevent moisture from entering the cell, and prevent leakage of current.

As an example, the outer layers 160 may surround surfaces of the cell laminate so that one end of the positive electrode layer 120 is exposed to the first surface and connected to the external electrode 112 on one side and one end of the negative electrode layer 140 is exposed to the second surface and connected to the external electrode 14 on the other side. For example, the outer layers 160 may be located on the third surface and the fourth surface of the cell laminate excluding the first surface and the second surface of the cell laminate or may be disposed on outer surfaces of the positive electrode layer 120 located at the lowermost end in a stacking direction of the cell laminate and the negative electrode layer 140 located at the uppermost end in the stacking direction of the cell laminate. Here, a solid electrolyte layer 130 may be disposed between the outer layer 160 and the positive electrode layer 120 or negative electrode layer 140 adjacent thereto.

As an example, the outer layer 160 may include a second solid electrolyte that is glass or glass ceramic that contains the element S (sulfur).

In this case, since the second solid electrolyte included in the margin layer 150 is also included in the outer layer 160, the cell laminate may be fired at a time with the solid electrolyte layer 130 and the margin layer 150 when it is manufactured.

The outer layer 160 may include an insulating material having an ionic conductivity of 1.0×10⁻¹⁰ S/cm or less, or 1.0×10⁻⁶ S/cm or less in order to impart insulating properties, and may include, for example, an insulating material such as a ceramic or resin.

The ceramic may include alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide. (GaAs), gallium nitride (GaN), barium titanate (BaTiO), zirconium dioxide (ZrO₂), a mixture thereof, or oxides and/or nitrides of these materials.

For example, the resin may include polyolefin such as polyethylene or polypropylene, polyester such as polyethylene terephthalate (PET), polyurethane, or polyimide.

As an example, the second solid electrolyte may be included in an amount of 20% by weight or more, 25% by weight more, or 30% by weight or more, and may be included in an amount of 100% by weight, 95% by weight or less, or 90% by weight or less, based on the total of the outer layer 160. If the second solid electrolyte is contained in an amount of less than 20% by weight, based on the total of the outer layer 160, it may be difficult to achieve insulation properties of the outer layer 160. Here, the % weight amount of the second solid electrolyte may be obtained in one outer layer 160, or may be an average value obtained in two outer layers 160. In one embodiment, the % weight amount of the second solid electrolyte may be obtained in each outer layer 160. For the % weight amount of the second solid electrolyte, other measurement methods and/or tools appreciated by one of ordinary skill in the art, even if not described in the present disclosure, may also be used.

As an example, the insulating material such as ceramic or resin may be included in an amount of 30% by weight or less, based on the total of the outer layer 160. If the insulating material is included in an amount exceeding 30% by weight, based on the total of the outer layer 160, it may be difficult to achieve co-sintering with the solid electrolyte layer 130. Here, the % weight amount of the insulating material may be obtained in one outer layer 160, or may be an average value obtained in two outer layers 160. In one embodiment, the % weight amount of the insulating material may be obtained in each outer layer 160. For the % weight amount of the insulating material, other measurement methods and/or tools appreciated by one of ordinary skill in the art, even if not described in the present disclosure, may also be used.

### Electrode Layer

The electrode layers 120 and 140 may include a positive electrode layer 120 and a negative electrode layer 140, and may essentially include current collectors 123 and 143 and active material layers 121, 122, and 141, 142 applied to at least one surface of the current collectors 123 and 143.

The positive electrode layer 120 may be formed by applying the positive electrode active material layers 121 and 122 to at least one surface of the positive electrode current collector 123, and the negative electrode layer 140 may be formed by applying the negative electrode active material layers 141 and 142 to at least one surface of the negative electrode current collector 143.

For example, the electrode layer located at the bottom relative to the stacking direction may be formed by applying the positive electrode active material layer 122 on one surface of the positive electrode current collector 123, and the electrode layer located at the uppermost end may be formed by applying the negative electrode active material layer 141 on one surface of the negative electrode current collector 143.

Also, the electrode layers located between the uppermost end and the lowermost end may be formed by applying the positive electrode active material layers 121 and 122 to both sides of the positive electrode current collector 123, or by applying the negative electrode active material layers 141 and 142 to both surface of the negative electrode current collector 143.

The positive electrode active material layers 121 and 122 may include a positive electrode active material and, optionally, a solid electrolyte. Additionally, the positive electrode active material layers 121 and 122 may optionally further include additives such as a binder or a conductive agent.

As an example, the positive electrode active material is not particularly limited as long as it can secure sufficient capacity of the all-solid-state battery 100. For example, the positive electrode active material may include lithium cobalt oxide, lithium nickel cobalt manganese oxide, lithium nickel cobalt aluminum oxide, lithium iron phosphorus oxide, lithium manganese oxide, or combinations thereof.

For example, the positive electrode active material may be a compound represented by the following formula: LiₐA_{1-b}M_{b}D₂ (where 0.90≤a≤1.8, 0≤b≤0.5); LiₐE_{1-b}M_{b}O_{2-c}D_{c} (where 0.90≤a≤1.8, 0≤b≤0.5, 0≤c≤0.05); LiE_{2-b}M_{b}O_{4-c}D_{c} (where 0≤b≤0.5, 0≤c≤0.05); LiₐNi_{1-b-c}Co_{b}M_{c}D_{α} (where 0.90≤a≤1.8, 0≤b≤0.5, 0≤c≤0.05, 0≤α≤2); LiₐNi_{1-b-c}Co_{b}M_{c}O_{2-α}X_{α} (where 0.90≤a≤1.8, 0≤b≤0.5, 0≤c≤0.05, 0≤α≤2); LiₐNi_{1-b-c}CO_{b}M_{c}O_{2-α}X₂ (where 0.90≤a≤1.8, 0≤b≤0.5, 0≤c≤5.05, 0≤a≤2); LiₐNi_{1-b-c}Mn_{b}M_{c}D_{α} (where 0.90≤a≤1.8, 0≤b≤0.5, 0≤c≤0.05, 0≤α≤2); LiₐNi_{1-b-c}Mn_{b}M_{c}O_{2-α}X_{α} (where 0.90≤a≤1.8, 0≤b≤0.5, 0≤c≤0.05, 0≤a≤2); LiₐNi_{1-b-c}Mn_{b}M_{c}O_{2-α}X₂ (where 0.90≤a≤1.8, 0≤b≤0.5, 0≤c≤0.05, 0≤α≤2); LiₐNi_{b}E_{c}G_{d}O₂ (where 0.90≤a≤1.8, 0≤b≤0.9, 0≤c≤0.5, 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, 0.001≤e≤0.1); LiₐNiGbO₂ (where 0.90≤a≤1.8, 0.001≤b≤0.1); LiₐCoGbO₂ (where 0.90≤a≤1.8, 0.001≤b≤0.1); LiₐMnGbO₂ (where 0.90≤a≤1.8, 0.001≤b≤0.1); LiₐMn₂GbO₄ (where 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (where 0≤f≤2); and LiFePO₂, wherein A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (where x=1 or 2), LiNi₃₋ₓMnₓO₂ₓ (where 0<x<1), LiNi_{1-x-y}CoₓMn₂O₂ (where 0≤x≤0.5, 0≤y≤0.5), LiFePO₂, TiS₂, FeS₂, TiS₃, or FeS₃.

The solid electrolyte may be any solid electrolyte available in the solid electrolyte layer 130 described above. The solid electrolyte may function as an ionic conduction channel within the positive electrode layer 120, thereby reducing the interface resistance.

The content of the solid electrolyte may be 0.1 parts by weight or more, 1 part by weight or more, or 10 parts by weight or more, and may be 80 parts by weight or less, 60 parts by weight or less, or 50 parts by weight or less, based on the total of 100 parts by weight of the positive electrode active material.

The conductive agent is not particularly limited as long as it has conductivity without causing chemical changes in the all-solid-state battery 100. For example, conductive agent may include graphite, such as natural or artificial graphite; carbon-based materials, such as carbon black, acetylene black, ketjen black, channel black, furnace black, lamp black, and summer black; conductive fibers, such as carbon fiber or metal fiber; carbon fluoride; metal powders, such as aluminum and nickel powder; conductive whiskers, such as zinc oxide and potassium titanate; conductive metal oxides, such as titanium oxide; and conductive materials, such as polyphenylene derivatives.

The content of the conductive agent may be 1 part by weight to 10 parts by weight, for example, 2 parts by weight to 5 pats by weight, based on the total of 100 parts by weight of the positive electrode active material. If the content of the conductive agent is within the above range, the finally obtained electrode may have excellent conductivity properties.

A binder may be used to improve bonding strength between an active material and a conductive agent. The binders may include, for example, polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diether polymer (EPDM), sulfonated EPDM, styrene butadiene rubber, fluorinated rubber, or various copolymers.

The content of the binder may be 0 part by weight to 50 parts by weight, for example, 1 part by weight to 50 parts by weight, or 2 parts by weight to 5 parts by weight, based on the total of 100 parts by weight of the positive electrode active material. If the content of the binder satisfies the above range, the active material layer may have high bonding strength.

The positive electrode current collector 123 is not particularly limited as long as it has conductivity without causing chemical changes in the positive electrode or the battery.

As an example, the positive electrode current collector 123 may be porous, such as a network or mesh-like, and may be a porous metal plate, such as stainless steel, nickel, aluminum, etc.

In addition, the positive electrode current collector 123 may be coated with an oxidation-resistant metal or alloy film to prevent oxidation.

As an example, the positive electrode current collector 123 may include graphite such as natural graphite or artificial graphite; carbon-based materials such as carbon black, acetylene black. Ketjen black, channel black, furnace black, lamp black, and summer black; conductive fibers, such as carbon fiber, carbon nanotube (CNT), vapor grown carbon fiber (VGCF), and metal fiber.

As an example, the positive electrode current collector 123 may further include one or more of solid electrolytes described above.

The negative electrode active material layers 141 and 142 may include a negative electrode active material and, optionally, a solid electrolyte. Additionally, the negative electrode active material layers 141 and 142 may optionally further include additives such as a binder or a conductive agent.

The negative electrode active material may be carbon-based material, silicon, silicon oxide, silicon-based alloy, silicon-carbon-based material composite, tin, tin-based alloy, tin-carbon composite, metal oxide, or combinations thereof, and may include lithium metal and/or lithium metal alloy.

The lithium metal alloy may include lithium and metals/metalloids capable of alloying with lithium. For example, metals/metalloids capable of alloying with lithium may include Si, Sn, Al, Ge, Pb, Bi, Sb, Si—Y alloys (where Y is an alkali metal, an alkaline earth metal, an element in groups 13 to 16, a transition metal, rare earth elements or a combination of these elements, but do not include Si), Sn—Y alloy (where Y is an alkali metal, an alkaline earth metal, an element in groups 13 to 16, a transition metal, a transition metal oxide such as lithium titanium oxide (Li₄Ti₅O₁₂), a rare earth element, or a combination of these elements, but does not include Sn), or MₙOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh. Ir, Pd, Pt, Cu, Ag, Au, Zn, Cd, B, Al, Ga, Sn, In, TI, Ge, P, As, Sb, Bi, S, Se, Te, Po, or a combination thereof.

In addition, oxides of metals/metalloids capable of alloying with lithium may be lithium titanium oxide, vanadium oxide, lithium vanadium oxide. SnO₂, SiOₓ (0<x<2), etc. For example, the negative electrode active material may include one or more elements selected from the group consisting of elements in groups 13 to 16 of the periodic table of elements. For example, the negative electrode active material may include one or more elements selected from the group consisting of Si, Ge, and Sn.

The carbon-based material may be crystalline carbon, amorphous carbon, or a mixture thereof. Crystalline carbon may be graphite, such as natural graphite or artificial graphite, in the form of amorphous, platelets, flakes, spheres, or fibers. In addition, amorphous carbon may be soft carbon (low-temperature calcined carbon) or hard carbon, mesophase pitch carbide, calcined coke, graphene, carbon black, fullerene soot, carbon nanotube, and carbon fiber.

Silicon may be Si, SiOₓ (0<x<2, for example 0.5 to 1.5), Sn, SnO₂, or a silicon-containing metal alloy and a mixture thereof. The silicon-containing metal alloy may include, for example, silicon and one or more of Al, Sn, Ag, Fe, Bi, Mg, Zn, in, Ge, Pb, and Ti.

The solid electrolyte may be any solid electrolyte available in the solid electrolyte layer 130 described above. The solid electrolyte may function as an ionic conduction channel within the negative electrode layer 140, thereby reducing the interface resistance.

The content of the solid electrolyte may be 0.1 pans by weight or more, 1 part by weight or mow, or 10 parts by weight or more, and may be 80 parts by weight or less, 60 parts by weight or less, or 50 parts by weight or less, based on the total of 100 parts by weight of the negative electrode active material.

The negative electrode active material layers 141 and 142 may also optionally include a conductive agent and a binder as described for the positive electrode active material layers 121 and 122.

The negative electrode current collector 143 is not particularly limited as long as it has conductivity without causing chemical changes in the negative electrode or the battery.

As an example, the negative electrode current collector 143 may be porous, such as a network or mesh-like, and may be a porous metal plate, such as stainless steel, nickel, aluminum, etc.

In addition, the negative electrode current collector 143 may be coated with an oxidation-resistant metal or alloy film to prevent oxidation.

As an example, the negative electrode current collector 143 may include graphite such as natural graphite or artificial graphite; carbon-based materials such as carbon black, acetylene black, Ketjen black, channel black, furnace black, lamp black, and summer black; conductive fibers, such as carbon fiber, carbon nanotube (CNT), vapor grown carbon fiber (VGCF), and metal fiber.

As an example, the negative electrode current collector 143 may further include one or more of solid electrolytes described above.

### External Electrode

The terminal of the positive electrode current collector 123 and the terminal of the negative electrode current collector 143 are exposed on both sides of the cell laminate of the all-solid-state battery 100, and external electrodes 112 and 114 may be connected and coupled to the exposed terminals. That is, the external electrodes 112 and 114 may be configured to be connected to the terminal of the positive electrode current collector 123 to have a positive electrode, and to be connected to the terminal of the negative electrode current collector 143 to have a negative electrode. If the terminals of the positive electrode current collector 123 and the terminals of the negative electrode current collector 143 are configured to face opposite directions from each other, the external electrodes 112 and 114 may also be located on each side.

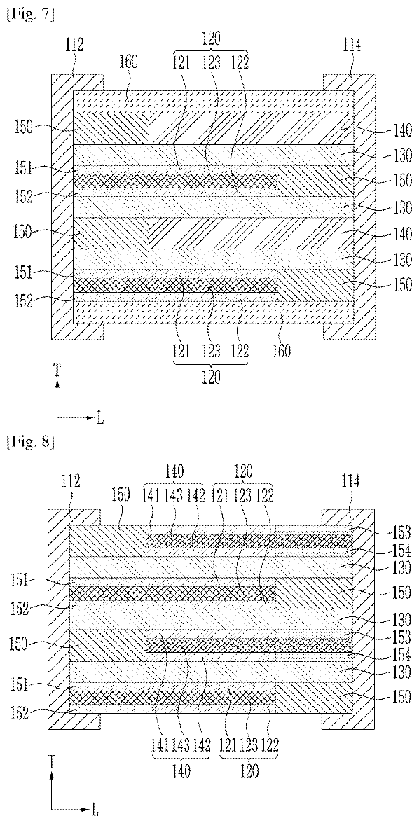

Referring to FIG. 3, FIG. 5, and FIG. 7, the external electrodes 112 and 114 can cover not only the cell laminate but also the lateral direction of the outer layer 160. That is, as the outer layer 160 is manufactured by firing at a time when manufacturing the cell laminate, and the external electrodes 112 and 114 are subsequently formed, the external electrodes 112 and 114 may also be located in a lateral direction of the outer layers 160.

The external electrodes 112 and 114 may include conductive metal and glass.

The conductive metal may be a conductive metal including, for example, copper (Cu), nickel (Ni), tin (Sn), palladium (Pd), platinum (Pt), gold (Au), silver (Ag), tungsten (W), titanium (Ti), lead (Ph), or an alloy thereof.

The glass component included in the external electrodes 112 and 114 may be a composition of mixed oxides. The glass component may include, for example, silicon oxide, boron oxide, aluminum oxide, transition metal oxide, alkali metal oxide, alkaline earth metal oxide, or combinations thereof. Here, the transition metal may be selected from zinc (Zn), titanium (Ti), copper (Cu), vanadium (V), manganese (Mn), iron (Fe), or nickel (Ni), and the alkali metal may be selected from lithium (Li), sodium (Na), or potassium (K), and the alkaline earth metal may be selected from magnesium (Mg), calcium (Ca), strontium (Sr), or barium (Ba).

A method of forming the external electrodes 112 and 114 is not particularly limited. For example, the external electrodes 112 and 114 may be formed by dipping the cell laminate in a conductive paste containing conductive metal and glass, or by printing the conductive paste on the surface of the cell laminate, such as by screen printing or gravure printing. In addition, various methods, such as by applying a conductive paste to the surface of the cell laminate, or by transferring a dried film of the conductive paste to the cell laminate may be used.

A stacked all-solid-state battery according to an embodiment includes: a cell laminate including a plurality of solid electrolyte layers, a plurality of positive electrode layers and negative electrode layers alternately disposed with the plurality of solid electrolyte layers interposed therebetween; and margin layers disposed at edges of the positive electrode layers and the negative electrode layers, respectively, in a lateral direction, wherein the solid electrolyte layers include a first solid electrolyte that is glass or glass ceramic that does not contain an element S (sulfur), and the margin layers include a second solid electrolyte that is glass or glass ceramic that contains the element S (sulfur).

As an example, the stacked all-solid-state battery may further include an outer layer located on one or both surfaces in a stacking direction of the cell laminate. The outer layer may include a second solid electrolyte that is glass or glass ceramic that contains the element S (sulfur).

As an example, the stacked all-state battery may include first and second external electrodes disposed adjacent to the cell laminate or the outer layer in a lateral direction and respectively connected to the plurality of positive electrode layers and the plurality of negative electrode layers.

Since the first and second solid electrolytes are the same as described above, a detailed description will be omitted herein.

Specific embodiments of the invention are described below. However, the examples described below are intended only to illustrate or described the invention in detail, and should not be construed as limiting the scope of the invention.

### Examples

### 1. Preparation of First Solid Electrolyte

The first solid electrolytes of Reference Examples 1 to 3 having the compositions shown in Table 1 below were prepared. The prepared first solid electrolyte may be included in the solid electrolyte layer green sheet and fired at a time with other layers when manufacturing a cell laminate of an all-solid-state battery.

### 2. Preparation of Second Solid Electrolyte

The second solid electrolytes of Preparation Examples 1 to 2 and Comparative Preparation Examples 1 to 6 having the compositions shown in Table 2 below were prepared. The prepared second solid electrolyte may be included in the margin layer or outer layer green sheet and fired at a time with other layers when manufacturing a cell laminate of an all-solid-state battery.

### Evaluation Examples

### 1. Pellet Ionic Conductivity Evaluation

A pellet including the first solid electrolyte and the second solid electrolyte prepared as above and having a thickness of about 3 mm is prepared, and then pressure firing was performed in a pressurized furnace at 10 MPa to 20 MPa for 10 to 30 minutes.

Both ends of the pressure-fired pellet are polished with sandpaper to form a flat surface. A sample is prepared by forming electrodes made of gold (Au) on both ends of the polished pellet. Then, the ionic conductivity was calculated by measuring the alternating current impedance (frequency: measured from 10⁻⁶ Hz or more to 10⁻⁴ Hz or less, voltage: a value between 50 mV and 500 mV) on the sample at room temperature (25° C.) using an impedance measurement device, and the results are shown in Tables 1 and 2 below.

### 2. Sintering Temperature Evaluation

Pressure firing of the pellets was performed at temperatures of 450, 475, 500, 525, 550, and 600° C.

After sintering, dense pellets with a relative density of 80% or more were formed, and the temperature at which the pellets are strong enough not to be damaged even when both ends of the pellets are polished in order to evaluate the ionic conductivity of the pellets was referred to as the sintering temperature. The sintering temperature should also be a temperature at which the crystallite materials constituting the glass-ceramic are sufficiently formed in the case of a glass-ceramic solid electrolyte.

The sintering temperature evaluation results are shown in Tables 1 and 2 below.

TABLE 1

| | | Pellet ionic | Sintering |
|---|---|---|---|
| | | conductivity | temperature |
| | Composition | (S cm⁻¹) | (° C.) |
| Reference | Li-B-Si-O | 1.E−07 | 500 |
| Example 1 | | | |
| Reference | Li-B-Si-P-Ge-Cl-O | 5E−06 | 550 |
| Example 2 | | | |
| Reference | Li-B-Al-Cl-O | 1E−06 | 525 |
| Example 3 | | | |

TABLE 2

| | | Pellet ionic | Sintering |
|---|---|---|---|
| | | conductivity | temperature |
| | Composition | (S cm⁻¹) | (° C.) |
| Preparation | Li-B-Si-S-O | 5E−10 | 500 |
| Example 1 | | | |
| Preparation | Li-B-Si-S-P-O | 5E−09 | 500 |
| Example 2 | | | |
| Comparative | Li-B-Si-O | 5E−08 | 450 |
| Preparation | | | |
| Example 1 | | | |
| Comparative | Li-B-Si-O | 1E−08 | 450 |
| Preparation | | | |
| Example 2 | | | |
| Comparative | Li-B-Si-P-Ge-O | 5E−08 | 550 |
| Preparation | | | |
| Example 3 | | | |
| Comparative | Li-B-Si-Al-O | Not measurable | Not densified |
| Preparation | | | |
| Example 4 | | | |
| Comparative | Li-B-Cl-O | Not measurable | Not densified |
| Preparation | | | |
| Example 5 | | | |
| Comparative | Li-B-Si-P-Ge-Al-O | 5E−08 | 500 |
| Preparation | | | |
| Example 6 | | | |

(In Table 2 above, “not measurable” means that the ionic conductivity cannot be measured because the solid electrolyte is not sufficiently densified even after sintering up to 600° C.)

Referring to Tables 1 and 2, it can be confirmed that the second solid electrolyte containing the element S prepared in Preparation Examples 1 and 2 had excellent insulating properties because the ionic conductivity was 5E-09 or less. In addition, it can be confirmed that since the sintering temperature was about 500° C., co-sintering with the first solid electrolyte prepared in Reference Examples 1 to 3 was possible.

On the other hand, it can be confirmed that the second solid electrolyte that did not contain the element S prepared in Comparative Preparation Examples 1 and 2 had an ionic conductivity of 1E-08 or more and the sintering temperature was excessively low, so both insulation properties and co-sintering properties were not excellent.

In addition, it can be confirmed that the second solid electrolyte prepared in Comparative Preparation Examples 3 and 6 did not have excellent insulation properties due to high ionic conductivity even though the sintering temperature was in a similar range to that of the first solid electrolyte. Furthermore, it can be confirmed that in the second solid electrolyte prepared in Comparative Preparation Examples 4 and 5, the solid electrolyte was not sufficiently densified in a range of 450° C. to 600° C., and the sintering temperature was excessively high.

It is to be understood that although the preferred embodiment of the present invention has been described above, the present invention is not limited thereto, but can be implemented in various modifications within the scope of the claims, the detailed description of the present invention, and the accompanying drawings, which also fall within the scope of the present invention.

### DESCRIPTION OF SYMBOLS

100: All-solid-state battery
112, 114: External electrode
120: Positive electrode layer
121, 122: Positive electrode active material layer
123: Positive electrode current collector
130: Solid electrolyte layer
140: Negative electrode layer
141, 142: Negative electrode active material layer
143: Negative electrode current collector
150, 151, 152, 153, 154: Margin layer
160: Outer layer

### INDUSTRIAL APPLICABILITY

The present disclosure relates to an all-solid-state battery has an advantage of being excellent in both insulating properties and co-sintering properties and thus applicable to various electrochemical devices and electronic devices.

1. An all-solid-state battery, comprising: a cell laminate including a solid electrolyte layer; a positive electrode layer and a negative electrode layer disposed with the solid electrolyte layer interposed therebetween; and margin layers disposed at edges of the positive electrode layer and the negative electrode layer, respectively, in a lateral direction,
wherein the solid electrolyte layer includes a first solid electrolyte that is glass or glass ceramic that does not contain an element S (sulfur), and
the margin layers include a second solid electrolyte that is glass or glass ceramic that contains the element S (sulfur).

2. The all-solid-state battery of claim 1, wherein
the first solid electrolyte is an oxide containing lithium (Li), and further containing boron (B), silicon (Si), aluminum (Al), phosphorus (P), germanium (Ge), chlorine (Cl), or combinations thereof.

3. The all-solid-state battery of claim 1, wherein
the second solid electrolyte is an oxide containing lithium (Li) and sulfur (S), and further containing boron (B), silicon (Si), phosphorus (P), aluminum (Al), germanium (Ge), chlorine (Cl), or combinations thereof.

4. The all-solid-state battery of claim 1, wherein
the second solid electrolyte is included in an amount ranging from 20% by weight to 100% by weight, based on the total of the margin layers.

5. The all-solid-state battery of claim 1, wherein
a sintering temperature of the first solid electrolyte and the second solid electrolyte ranges from 470° C. to 550° C.

6. The all-solid-state battery of claim 1, wherein
an ionic conductivity (25° C.) of the first solid electrolyte is 1×10⁻⁷ S/cm or more.

7. The all-solid-state battery of claim 1, wherein
an ionic conductivity (25° C.) of the second solid electrolyte is 5.0×10⁻⁹ S/cm or less.

8. The all-solid-state battery of claim 1, wherein
the margin layers further include an insulating material including ceramic or resin.

9. The all-solid-state battery of claim 8, wherein
the ceramic includes alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, or oxides or nitrides of these materials.

10. The all-solid-state battery of claim 8, wherein
the resin includes polyethylene, polypropylene, polyethylene terephthalate (PET), polyurethane, polyimide, or combinations thereof.

11. The all-solid-state battery of claim 1,
further comprising an outer layer disposed on one or both surfaces of the cell laminate in a stacking direction,
wherein the outer layer includes the second solid electrolyte that is glass or glass ceramic that contains the element S (sulfur).

12. An all-solid-state battery, comprising: a cell laminate including a solid electrolyte layer; a positive electrode layer and a negative electrode layer disposed with the solid electrolyte layer interposed therebetween; and margin layers disposed at edges of the positive electrode layer and the negative electrode layer, respectively, in a lateral direction, and
an outer layer disposed on one or both surfaces of the cell laminate in a stacking direction,
wherein the solid electrolyte layer includes a first solid electrolyte that is glass or glass ceramic that does not contain an element S (sulfur), and the margin layers or the outer layer includes a second solid electrolyte that is glass or glass ceramic that contains the element S (sulfur).

13. The all-solid-state battery of claim 12, wherein
the first solid electrolyte is an oxide containing lithium (Li), and further containing boron (B), silicon (Si), aluminum (Al), phosphorus (P), germanium (Ge), chlorine (Cl), or combinations thereof.

14. The all-solid-state battery of claim 12, wherein
the second solid electrolyte is an oxide containing lithium (Li) and sulfur (S), and further containing boron (B), silicon (Si), phosphorus (P), aluminum (Al), germanium (Ge), chlorine (Cl), or combinations thereof.

15. The all-solid-state battery of claim 12, wherein
the second solid electrolyte is included in an amount ranging from 20% by weight to 100% by weight, based on the total of the margin layer.

16. The all-solid-state battery of claim 12, wherein
the second solid electrolyte is included in an amount ranging from 20% by weight to 100% by weight, based on the total of the outer layer.

17. The all-solid-state battery of claim 12, wherein
a sintering temperature of the first solid electrolyte and the second solid electrolyte ranges from 470° C. to 550° C.

18. The all-solid-state battery of claim 12, wherein
an ionic conductivity (25° C.) of the first solid electrolyte is 1×10⁻⁷ S/cm or more.

19. The all-solid-state battery of claim 12, wherein
an ionic conductivity (25° C.) of the second solid electrolyte is 5.0×10⁻⁹ S/m or less.

20. A stacked all-solid-state battery, comprising: a cell laminate including a plurality of solid electrolyte layers, a plurality of positive electrode layers and negative electrode layers alternately disposed with the plurality of solid electrolyte layers interposed therebetween; and
margin layers disposed at edges of the positive electrode layers and the negative electrode slayer, respectively, in a lateral direction,
wherein the solid electrolyte layers include a first solid electrolyte that is glass or glass ceramic that does not contain an element S (sulfur), and
the margin layers include a second solid electrolyte that is glass or glass ceramic that contains the element S (sulfur).

21. The stacked all-solid-state battery of claim 20,
further comprising an outer layer disposed on one or both surfaces of the cell laminate in a stacking direction.

22. The stacked all-solid-state battery of claim 21, wherein
the outer layer includes a second solid electrolyte that is glass or glass ceramic that contains the element S (sulfur).
